(19) United States
(12) Patent Application Publication
(10) Pub. No.: US 2015/0015076 A1
(43) Pub. Date: Jan. 15, 2015

(54) CHARGING SYSTEM AND POWER FAILURE DEVICE DETECTING POWER FAILURE OF LED LIGHT

(71) Applicant: Seonghoon Park, Siheung-si Gyeonggi-do (KR)

(72) Inventor: Seonghoon Park, Siheung-si Gyeonggi-do (KR)

(21) Appl. No.: 14/376,908

(22) PCT Filed: Feb. 6, 2013
(86) PCT No.: PCT/KR2013/000935

§ 371 Date: Aug. 6, 2014

(30) Foreign Application Priority Data
Feb. 6, 2012 (KR) 10-2012-0011850

(51) Int. Cl. H02J 9/06; H02J 7/00; H05B 33/08

(52) U.S. Cl. CPC H02J 9/061; H05B 33/0845; H05B 33/0884; H02J 7/0068
USPC 307/66; 324/414

(57) ABSTRACT

In an emergency lighting apparatus, charging efficiency is increased by individually charging cells in a power storage unit. When a power failure or other situation occurs requiring the actual use of the emergency lighting device, the proper operation of the emergency lighting device is ensured. In particular, the disadvantage of additional wiring in a bulb-type lighting fixture and the disadvantage of grounding are addressed so that power can be continuously supplied to the emergency lighting device and the emergency lighting device functions properly.

### TECHNICAL FIELD

The present invention relates to a charging system and a power failure detecting device of an LED light, and more particularly, to a charging system and a power failure detecting device of an LED light that overcome various problems occurring when secondary batteries are used and perform high-speed charging within a short time so that an emergency lighting device may be easily used in an actual emergency to ensure a human's view in an emergency, by using various secondary batteries as storage batteries used in a lighting device.

### BACKGROUND ART

In general, installation of emergency lighting devices that enable preparing for a state of emergency such as a power failure has obligated in workplaces such as large buildings or public places in addition to lighting devices which are fundamentally installed. The emergency lighting devices are designed to be turned on and in this case, secondary batteries primarily used as power supplies of the emergency lighting devices include a lithium ion battery or a lithium polymer battery, a lead battery, a nickel hydride battery, a nickel cadmium battery, and the like.

The aforementioned disadvantage occurs due to a problem in a battery and a charging system as a major cause and in more detail, since excessive charging is continued in normal times in order to ensure a full charging state of the battery at the time when the emergency lighting device needs to be turned on, the life-span of the battery is extremely shorter than that of a battery used in a general electrical product. Therefore, when other situations such as the power failure, and the like in which the emergency lighting device needs to be actually used occurs within a predetermined time after initial installation of the emergency lighting device, the emergency lighting device cannot normally perform its own function due to the aforementioned cause.

Accordingly, development of a charging device of LED light and a power failure sensing system which are newer and more advanced is required to solve the aforementioned problem of the secondary battery and increase charging efficiency of the storage unit constituted by a plurality of cells so that the emergency lighting device can be easily used in case of actual emergency and ensure people's views in case of emergency.

### DETAILED DESCRIPTION OF THE INVENTION

### Technical Problem

The present invention is provided to solve the technical problems, secondary batteries used in the lighting device generally use a lithium-ion battery, a lithium-polymer battery, a lead battery, a nickel-hydride battery, a nickel-cadmium battery, and the like, and a lithium-iron phosphate battery and a hybrid battery have been newly used. Due to a characteristic of the secondary battery, since the secondary battery is prepared so that a withstand voltage per cell is generally less than 2.3 V to 4.5 V, if an output voltage of an internal converter or an inverter is stored in the LED light, a plurality of power storage units are connected to each other in series within a withstand-voltage available range (e.g. when a withstand of one battery is 2.5 V and the converter output voltage is 15 V, six or more power storage units are connected to each other in series), and even in the case of using an electric double-layer capacitor (EDLC), the secondary battery has been used to correspond to the output voltage of the converter or the inverter by connecting the plurality of cells in series.

As the aforementioned problem, when the input voltage during power failure is a predetermined value or less, the present invention relates to a voltage amplifying circuit that may improve costs and efficiency with a small number and ensure a more stable operation of the lighting device by outputting the stored voltage of the power storage unit through a step-up transformation unit (step-up DC-DC converter), and particularly, adjust the output voltage by reducing the number of input batteries, by storing a higher output voltage of the converter than an available withstand voltage of the battery as an available withstand voltage of the battery or the hybrid capacitor and the electric double-layer capacitor by installing a decompression and transformation unit (decompression DC-DC converter).

As another object of the present invention, it is cautious to reduce the number of batteries or hybrid capacitors and electric double-layer capacitors by a half of the existing circuit so as to be advantageous to high integration as described in the illustrated configuration.

As another object of the present invention, since an existing light apparatus for power failure is configured by a single-phase two wire type or three wire type, when the light apparatus intends to be used as an emergency light by considering electric wires of a current building, there are an disadvantage to wire one wire from a main power to a lighting fixture of the building and inconvenience to separately install a ground.

In Korea publication Utility Model 2000-0005639, in order to compensate for the shortcomings in the related art, a background art of a fluorescent-light stabilizer for power failure configured by a single-phase two wire system so as to be simply installed by only the wires in the light apparatus without inconvenience to wire one wire from the main power to the lighting fixture proposes a detecting method of directly connecting the wire. However, the fluorescent stabilizer for power failure is configured by an electronic stabilizer which is connected with fluorescent light during power input, not connected to the fluorescent light during the power failure, a battery charging circuit in which a voltage charged in the battery is used during the power failure by charging the battery during the power input, a power failure detecting circuit connecting the power storage unit and the inverter during the power failure, and an inverter which is not connected to the fluorescent light during power input but connected to the fluorescent light during the power failure, and as a result, peripheral circuits are complicated, a lot of costs are required during production, a technique of simply configuring and easily installing the circuit is required, and it is difficult to be configured in the bulb-type lighting apparatus.

### Means for Solving the Problem

A charging system and a power failure detecting device of an LED light according to the exemplary embodiment includes a power failure detection and determination unit of the external power determining the external power supply, a converter (AC-DC or DC-DC converter), a charging unit charging a plurality of batteries (cells), a power storage unit, a low voltage control unit, a transformation unit, a selective control unit, and a constant-current control unit.

The external power supply unit receives main power from the outside, and the power failure detection and determination unit of the external power determines whether the external power is stably supplied to generate a power selection signal determining whether or not select and output the external power or select and output charging power, and in the case where the external power is not supplied (e.g. the case where the external power supply is interrupted due to the power failure or the emergency or the voltage is reduced to a predetermined level or less), a voltage and a current stored in the power storage unit is supplied to the LED module by outputting a main-power interruption signal of the power failure detection and determination unit.

Additionally, the selective control unit may further include a circuit or a step that supplies the power of the power storage unit to the LED module by selecting the stored power in response to flame detection, temperature detection, human's body detection, vibration (earthquake) detection, and external illumination detection.

The charging unit may further include a charging amount control unit for enhancing charging efficiency by individual charging each cell of the power storage unit configured by a plurality of cells and prevent the deterioration of the power storage unit by detecting an internal temperature of the LED light, and may further include a charging circuit unit that outputs the stored voltage of the power storage unit through a step-up transformation unit (step-up DC-DC converter) by storing a high output voltage of the converter as a withstand available voltage of the power storage unit by installing a decompression and transformation unit (decompression DC-DC converter) to improve costs and efficiency with a small number.

In the power failure detecting device of the LED light according to the exemplary embodiment of the present invention, when the current flows, an induced current flows in the detection unit 50 wound around the power failure detection and determination unit, and the induced current is applied to the power failure detection and determination circuit after being rectified by a current rectifying means. Accordingly, the user provides the charging system and a power failure detecting device of an LED light without installing a separate ground wire by embedding the power failure detecting device of the present invention which is inserted to a power cable or configuring a complex circuit, and in an existing power failure detecting method, since a ground wire and a terminal directly contact the electric wire because the electric wire is a live wire, a separate ground should be installed to be detected, and further, internal circuit errors occur due to natural disasters and the like during measurement using the ground, and since an occurrence number is increased every year, fundamental countermeasures thereof have been required.

The present invention is to compensate for shortcomings of the existing lighting devices, and provides the charging system and a power failure detecting device of an LED light configured to be simply installed by only a wire in a lighting fixture without inconveniency to be wired from the main power to the lighting fixture.

### Effect of the Invention

According to the charging system and a power failure detecting device of an LED light according to the present invention,

1) It is possible to enhance charging efficiency so the charging is possible at a high speed at a short time by dividing the power storage unit configured by a plurality of cells into respective cells,
2) improve costs and efficiency with a small number by outputting the stored voltage of the power storage unit through a step-up transformation unit (step-up DC-DC converter) by storing a high output voltage of the converter as a withstand available voltage of the power storage unit by installing a decompression and transformation unit (decompression DC-DC converter), and ensure a more stable operation of the lighting device.
3) The present invention provides a power failure detecting device of the LED light without installing a separate ground wire by embedding a live-wire checking device and configuring a complex circuit.
4) It is possible to dynamically determine the power failure determination in proportion to an output value by outputting the output value of the power failure determination by a non-contact type electro scope (a method of amplifying and detecting electro static electricity by electro static induction) in a bulb-type light or a stabilizer-type LED light.
5) In the case where a power failure in the building, an earthquake, and various disasters occur, it is possible to has an effect without lighting off the light for the corresponding time and a power-failed time according to a power amount charged in the battery by determining a time when the power failure is continuous and simply install the power failure detecting system by only the internal wire of the lighting fixture as a single-phase two wire system.

### BRIEF DESCRIPTION OF DRAWINGS

A brief description of respective drawings is provided to more sufficiently understand drawings cited in the detailed description of the present invention.

FIG. 1 is a configuration diagram schematically illustrating basic configurations of a charging system and a power failure detecting device of an LED light according to the present invention.

FIGS. 2 and 3 are a schematic configuration diagram of a battery charging circuit according to the present invention and a charging exemplary diagram illustrating a capacity trend between cells when a capacity deviation between the cells during charging without an even charging device of the cells.

FIG. 4 is a configuration diagram illustrating a configuration of a charging device using an external auxiliary power supply according to the present invention.

FIGS. 5 and 6 are a configuration diagram illustrating a schematic flow by a sensor sensing input of a selective control unit according to the present invention and a block diagram illustrating a configuration of the selective control unit.

FIGS. 7 and 8 are a detailed configuration block diagram of a power failure detection and determination unit and a detecting method of a detection unit in an exemplary embodiment of a power failure detecting system of an LED light according to the present invention.

FIGS. 9 and 10 are circuit diagrams illustrating an example of a power failure detection and determination output and a circuit of the detection unit of the power failure detecting system of an LED light according to the present invention.

### DESCRIPTION OF REFERENCE NUMERALS AND SYMBOLS

10: Converter 11: Selective control unit 12: Constant current control unit
13: LED module 14: Power failure detection and determination unit 15: Charging unit
15A: Decompression and transformation unit 15B: Charging circuit unit 16: Power storage unit
16A: Battery (cell) 16B: Low voltage control unit 17: Output transformation unit
30: Auxiliary power input terminal 31: Transformation unit 32: Switching element
33: Current sensor 34: PWM generator 35: Current detection sensor
36: External auxiliary power 37: Temperature sensor 38a: PIR sensor
38b: Flame sensor 38c: Vibration sensor 38d: Event signal
39: Radio receiver
40: current rectifying diode 41: Decompression resistor 42: Capacitor
50: Detection unit 51: Amplifying unit 52: Live-wire detection unit
53: Switching unit 54: Electric wire 55: Switching element for controlling

### BEST MODE FOR CARRYING OUT THE INVENTION

Prior to describing detailed contents for carrying out the present invention, products in which a battery is embedded in the existing LED light device are being sold on the market and problems of products interiorly and exteriorly having the battery therein are pointed out due to characteristics of Led light severely emitting heat. Therefore, a battery chemically storing electric energy is constituted by a plurality of cells, and as a result, if even one of the respective cells is charged while cells are in an uneven state even though pack voltage connected in series is within a set range, the respective cells are in a dangerous situation due to the unevenness between the cells and unevenness per cell occurs when the respective cells are charged due to variability of an acceptance range, variability in assembling the cells, a temperature deviation in a capacitor pack depending on an assembly position, and different discharge cycles/discharge rates of the respective cells caused by the unevenness.

Hereinafter, exemplary embodiments of the present invention will be described below in detail according to the accompanying drawings.

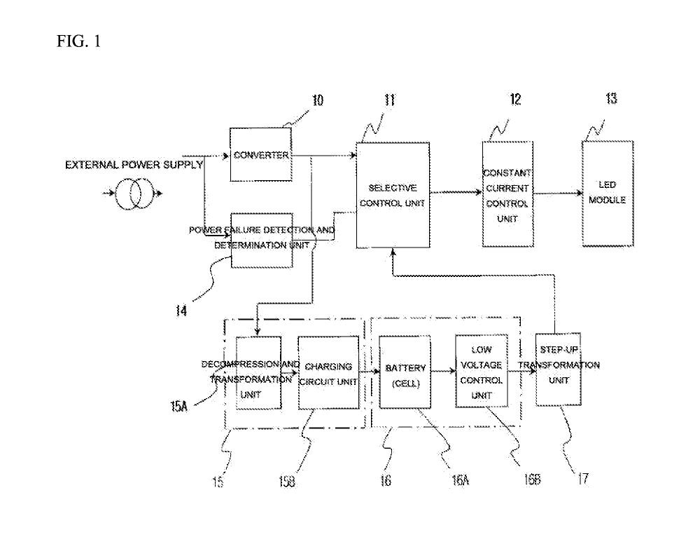

In FIG. 1 that is a configuration diagram schematically illustrating basic configurations of a charging system and a power failure device of detecting a power failure of an LED light according to the present invention, external power is supplied to a converter by filtering a common power supply through an electro magnetic interference (EMI) filter for intercepting electromagnetic waves in the converter.

A converter 10 further includes a fuse for protecting an LED light device from overcurrent between the common power supply and the EMI filter.

Power is supplied to the constant current control unit 12 to which power outputted from a power input unit, a power failure detecting determining unit 14, and a power storage unit 16 of the converter 10 receiving the power from the outside as peripheral configurations of the selection control unit 11 is compared with power output from a power input unit of an output transforming unit 17, external power, and power of the power storage unit to be selectively output.

An additional configuration of the selective control unit 11 may include a PR sensor, a vibration (earthquake sensing) sensor, a radio receiving unit 39, and the like, and may further include a filed effect transistor (FET) unit.

Additionally, in an existing prior power failure detecting method, in order to know whether an electric wire is a live wire or not and how much voltage value is if the live wire, since a ground wire and a terminal need to directly contact the electric wire, a separate ground needs to be installed and thus detection is possible. Particularly, in the case of a bulb-type lighting device, since an insulation state of a measuring instrument needs to be sufficiently ensured, a separate group is installed, and as a result, there are problems in that a manufacturing thereof is difficult, a volume thereof is large and heavy, and thus use or storage installation is inconvenient. The electric wires used in home, factory offices, or the like are in an insulating coated state, and when a current flows in a conductor, a few of electronic field is applied to a coated insulator.

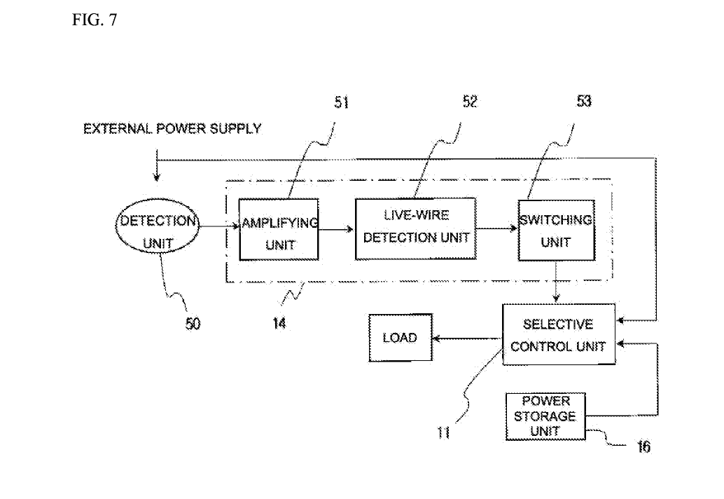

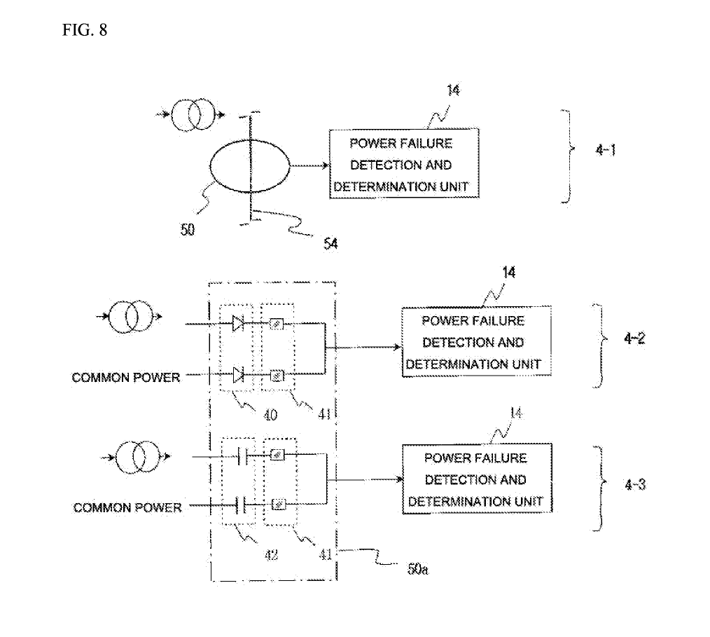

In such a state, as described above, when describing a configuration and an operation of the power failure detecting system of the LED light device according to the present invention in FIGS. 7 and 8, a detection unit 50 may be formed in a spiral shape, a ring shape, and a “C” shape, and when the current flows in a conductor core wire within the electric wire 54, electromotive force is induced according to the Faraday's law. An amplifying unit 51 is electrically connected with the detection unit to receive a signal of the detection unit 50 to amplify the induced current. In this case, by the signal of the amplifying unit 51, the live wire detecting unit 52 is configured so that an optimum driving voltage is applied to a switching unit 53, to apply the optimum driving voltage and the switching unit 53 may be configured in a best shape so that a sensing signal of an external power supply is output to the selection control unit 11 with a digital value of 0 or 1 and low or high when main power flowing the conductor core wire of the detecting unit 50 is stably supplied to control whether the power supply of the power storage unit 16 or external power supply is selected.

### Mode for Carrying Out the Invention

Referring to FIG. 1, the converter 10 receiving the external power may further include an EMI filter, a current rectifying diode, a transformation unit, a power supply unit, a switching unit, an auxiliary power unit, and a measuring unit. All of the illustrated constituent elements may not be essential constituent elements, and one or more constituent elements (for example, the transformation unit and the like) may be omitted.

As a result, the power failure detection and determination unit 14 provided in the present invention includes a simple auxiliary power supply function and a function of transferring a signal notifying that the external power supply is suddenly interrupted to the selective control unit 11, and thus an electronic device may take a countermeasure against self-power interruption by using the signal.

When the external power supply is normally supplied, the power failure detection and determination unit 14 recognizes that the main power is stably supplied and outputs a power selection signal corresponding thereto to the selective control unit 11. For example, when the main power is stably supplied, the power selection signal is output with a digital value of 1 or 0, and the selective control unit 11 receives the main power when the power selection signal having the value of 1 or 0 is input to output the external power to a constant-current control unit 12 and supply the output external power to an LED module 13. In this case, the selective control unit 11 may have an electric switching structure such as a relay operating in response to the power failure detection and determination unit 14 and a switching element 55 for controlling. In this case, the selective control unit 11 or the power failure detection and determination unit 14 does not generate an external power supply interruption signal.

A charging system of the LED light device according to the present invention of FIG. 1 will be described in detail.

By supplying power output from a converter AC-DC or DC-DC connected to the external power to receive AC power or DC power, a charging transformation unit 15A decompresses the power at an operational power level of the charging unit and supplies the power to a charging circuit unit 15B to be evenly charged at a decompressed voltage level. As illustrated in FIG. 1, when the power output from the charging unit 15 that is configured by the charging transformation unit 15A and the charging circuit unit 15B of the charging system of the LED light according to the present invention is supplied to the power storage unit 16, the power storage unit 16 formed when a battery (cell) and a low voltage control unit 16B are seated at the inside or the outside thereof which are the constituent elements of the power storage unit 16 receives the power of the charging unit to start to charge a charging battery 16A and the like (herein, the name of the battery or the cell is considered to be the same).

When the external power supply is not a user's intent but power interruption (power failure/disaster/fire signal), the power failure detection and determination unit 14 outputs a predetermined value, and the power charged in the power storage unit 16 is output to an output transformation unit 17 to be supplied to the selective control unit 11 as the same or a similar voltage as or to an output voltage of the converter 10 (e.g. output by stepping-up to 12 V when the converter voltage is 12 V), and then the power is received from the power storage unit 16 instead of the external power supply to be supplied to the LED module 13.

Further, the selective control unit 11 may provide a separate control switch so that the power supply is switched into an open state by the control of the selective control unit 11 when the user inputs an operation end command while the power is supplied by the power storage unit 16 so that the driving power is not supplied (power interruption). Of course, the control switch is omitted and thus the corresponding period may be maintained in a short state at all times, and the power interruption may be processed with software by the operation of the selective control unit 11.

Here, as a function of the low voltage control unit 16B, is to prevent a cell voltage from excessively dropping to a low voltage due to an internal driving circuit of the output transformation unit 17.

Additionally, in any one of the charging unit 15, the charging circuit unit 15B, and the power storage unit 16, a full-charging indicator, a low voltage indicator, or a charging amount display indicator is configured, and self-circuits for protecting a high surge voltage generated when the power supply is suddenly interrupted or large noise may be driven.

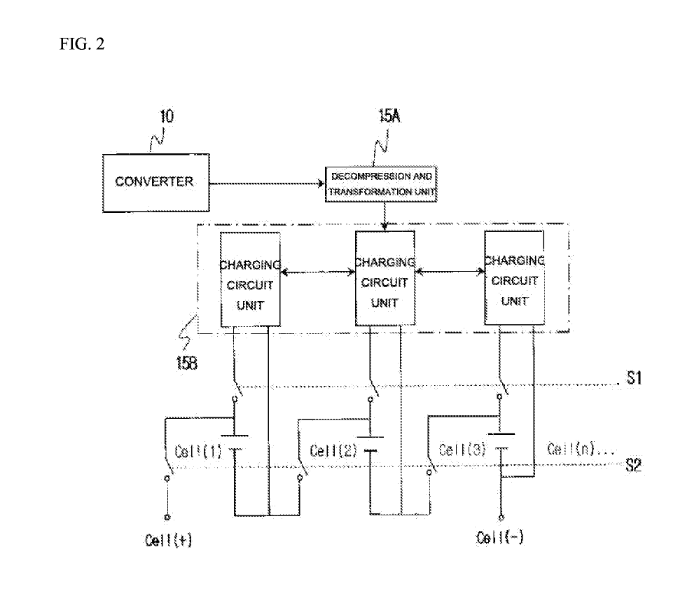

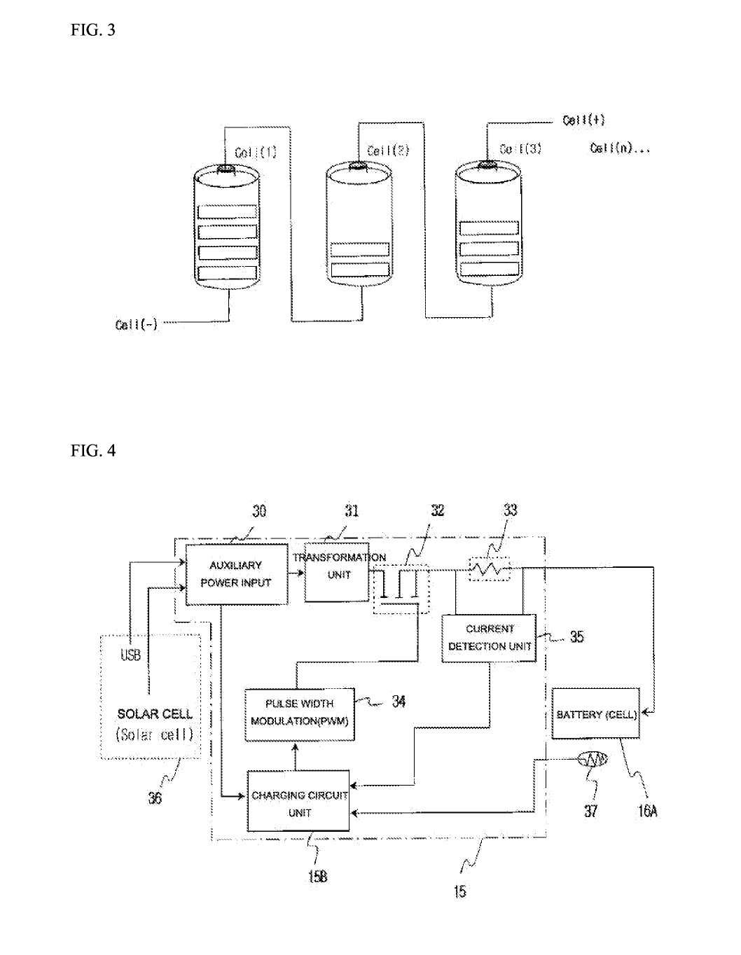

FIGS. 2 and 3 are a schematic configuration diagram of a battery even charging circuit according to the present invention and a charging exemplary diagram illustrating a capacity trend between cells when a capacity deviation between the cells during charging without an even charging device of the cells.

The present invention illustrated in FIGS. 2 and 3 relates to an even charging device of a battery (cell), and more particularly, to a lithium-ion battery, a nickel-hydride battery, a lithium polymer battery, an electric double-layer capacitor (EDLC) and a hybrid capacitor (hereinafter, referred to as a cell) as an individual charge between the cells which are invented to equalize the battery at a predetermined ratio by a method of individual charging in a low voltage cell and a high voltage cell among the respective cells, solve a thermal problem, and simplify circuit implementation to maximize a lifespan and efficiency of the battery.

As such, when the cells are uneven, as an expected result, the cells are connected to each other in series and thus like FIG. 3, the respective cells are uneven, and the charging needs to stop by a battery which is first charged, and as a result, careful monitoring and controlling are required so as to prevent the battery from being damaged due to overcharging. As an example, evenness between the cells of a lead battery may be solved by controlling full-charging and over-charging.

Hereinafter, a preferable exemplary embodiment of the present invention will be described in detail with reference to the accompanying drawings. The accompanying drawings are not illustrated by a reduced scale, and like reference numerals of each drawing designate like constituent elements.

When the power of the converter 10 is supplied, switches S1 and S2 which correspond to the output signal of the charging circuit unit 15B to which a voltage that is transformed to a predetermined value in the charging transformation unit 15A are operated to supply the charge between the cells from the charging circuit unit 15B, and thus cells Cell(1), Cell(2), and Cell(3) are configured in parallel to control the supply of the charging voltage.

In this case, the supply of a cell charging voltage corresponding to an output signal of S1 which is output from the charging circuit unit 15B to be supplied to each cell is controlled, and the S1- and S2 may be configured to operate at a predetermined period or reversely. As illustrated in FIG. 2, the switch S1 switched by the charging unit 15 or the charging circuit unit 15B, and an FET and a TR switching a driving current of the S2 which reversely operates with the S1 may be configured.

For example, when the operations of the S1 and S2 is described,

in the case where the voltage which is transformed at a predetermined value in the charging transformation unit 15A by supplying the input power of the converter 10 is supplied to the charging circuit unit 15B, as a detection voltage of the charging transformation unit 15A or the charging circuit unit 15B, the S1 is switched and turned on, and the charging is performed without unevenness between the cells. In this case, the S2 turns off a series configuration between a plurality of cells, and accordingly, the charging circuit unit 15B operates to individually evenly charge the cells. At the time, the switch S2 switched by the charging circuit unit 15B stops an electric series operation between the cells to perform a protection function. On the other hand, when the cells are full-charged to discharged or there is no supply voltage of the converter 10, the S1 may be controlled to be switched and turned off and the S2 may be controlled to be switched and turned on.

Additionally, as a configuration to be described as a comparator (not illustrated), when voltages among an inversion input terminal connected to the charging circuit unit, a non-inversion input terminal connected between the cells, and the cells are lower than the voltage of the charging circuit unit, the cells having high levels are configured to be connected in parallel to output a charging signal S1, and when the voltage between the cells is higher than the voltage of the charging circuit unit, the cells having low levels are configured to be connected in series to output a discharging signal S2, and the S1 and S2 may be replaced and configured to reversely operate.

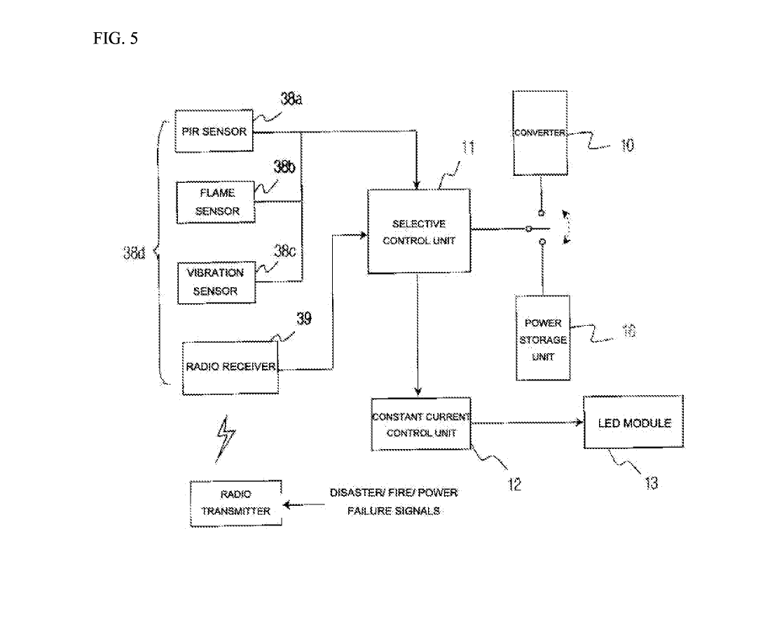

Before a configuration diagram illustrating a schematic flow by a sensor sensing input of the selective control unit according to the present invention of FIG. 5 is described, outputs set to be output in a designated situation of a PIR sensor 39a, an illumination sensor (not illustrated), a flame sensor 38b, a vibration sensor 38c, a radio receiver 39, and the like are called event signals 38d.

Sensing signals for detecting whether the designated events (for example, disaster/fire/power failure signals received from the radio receiver, a PIR sensor detection signal, an earthquake signal detected by the vibration sensor, a predetermined illumination value of indoor and outdoor fire detection detected by the flame sensor, and the like) are generated are generated to be provided to the selective control unit 11.

An event detection unit may include one or more of, for example, the PIR sensor 39a, the flame sensor 38b, the vibration sensor 38c, the radio receiver 39 receiving external radio transmission, and the illumination sensor (not illustrated) for generating the sensing signal.

The selective control unit 11 detects the event signal 38d to detect the voltage supplied from the converter 10. However, when there is no voltage value of the converter, the selective control unit 11 determines that the power supply is performed by the power storage unit 16 and performs lighting on/off of the LED module 13 in the emergency. In this step, a switching unit which is switched by electric switching of the selective control unit 11 is illustrated in FIG. 5 to estimate a selection which the power supply is possible by a pre-stored process from the selective control unit 11. Hereinafter, the selective control unit 11 determines the lighting on/off by analyze the input sensing signal and determining event generation or not.

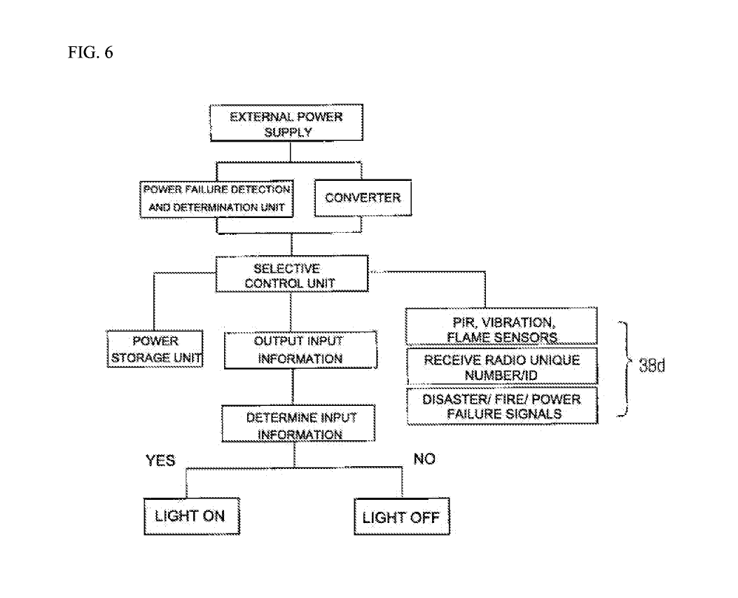

FIG. 6 is a flowchart illustrating a block diagram illustrating a configuration of the selective control unit according to the present invention.

Referring to FIG. 6, the selective control unit includes a converter receiving external power and a power failure detection and determination unit.

The selective control unit includes event signals, that is, the PIR sensor 39a, the flame sensor 38b, the vibration sensor 38c, and the radio receiver 39.

The selective control unit may determine whether the power supply is provided from the converter driving power supply and the power storage unit by using information provided by the event signal 38d, and may control rapid processing to be performed by selecting the power supply to be supplied from the power storage unit when the external power supply is interrupted and recognizing disaster/fire/power failure signals of the radio receiver.

The selective control unit determines an event detection or not by using a sensing signal input from the event signal 38d, and determines whether the power supply is performed by the auxiliary power supply unit of the power storage unit to control the corresponding operation to be performed. Further, the selective control unit controls so that each constituent element may perform the assigned function described above, determines input information after outputting the input information, and determines lighting or not of the LED module 13 by the PIR sensor, earthquake by the vibration, the fire by the flame detection, and the disaster information and the power failure signal by the radio receiver, and the like to perform lighting on or off of the LED module 13, and additionally, the illumination sensor may exemplify a photo sensor, a CDS, and a solar module.

It is assumed that a unique number (or an ID) for each receiver is allocated to radio receiver individually allocated to the LED light.

Thereafter, the input information, that is, the unique number and the ID of the LED light is transmitted to the radio receiver in the LED light designated through a radio transmitter in the output and determination of the input information.

Additionally, the selective control unit may be a means for receiving a user operation command, and may include one or more of, for example, a mechanical key button, a touch sensor, an infrared remote control receiver, and the like.

Here, when a method of detecting vibration and a human's body detection by the PIR sensor are exemplified, if the LED light is shaken by the vibration generated while a building is shaken by the earthquake or natural disasters similar to the earthquake, the detection of the vibration sensor installed at the lower center of the LED light is interlocked in a horizontal or vertical direction and a vibration weight is shaken, and as a result, a reed switch (not illustrated) which is maintained in an “on” state by magnetic force of a permanent magnet provided in the vibration weight (not illustrated) is turned “off”. Accordingly, the selective control unit detects the “off” signal of the reed switch to control the LED module and determine the lighting or not. Simultaneously, the selective control unit may transfer an alarm signal to generate an alarm sound, or drive self-circuits for lighting an alarm lamp.

Further, the human's body detection is based on a so-called passive infrared detection (PR sensor) method in which an infrared element captures a change state of an infrared amount of about 10 μm which is emitted from the human's body.

That is, when a difference between an indoor temperature and a human's body temperature is 3° C. or more and an object moves at a speed of 30 cm to 2 m per second, a principle of entering a sensing zone is used. For example, when it is assumed that a human with a temperature of 34° C. enters the indoor with a temperature of 24° C., the power of the lighting unit and the like is automatically turned on while the sensor detects the temperature difference in a moment. On the contrary, after a person is gone or if there is no movement, since there is no the temperature difference, the switch may automatically prevent unnecessary power consumption.

FIG. 4 is a configuration diagram illustrating a configuration of a charging device using an external auxiliary power supply according to the present invention.

Referring to FIG. 4, the charging device includes an auxiliary power supply input terminal 30 receiving an external auxiliary power supply 36 such as a USB and a solar cells, a transformation unit 31, a switching element 32, a current sensor 33, a PWM generator 34, a current detection unit 35, a temperature sensor 37, a battery (cell) 16A, and a charging circuit unit 15B.

In the configuration illustrated in FIG. 4, when the external power of the auxiliary power supply input terminal 30 is applied, the power is applied to the transformation unit 31 and the charging circuit unit 15B, and in this case, the charging circuit unit 15B controls and outputs a pulse width modulation (PWM) duty to switch the switching element 32. The charging circuit unit 15B is connected between the switching element 32 and the current sensor 33 to intermittently output the current, and the current detection unit 35 is connected to the current sensor 33 and the charging circuit unit 15B to detect the current between the switching element 32 and the battery (cell) 16A.

The charging circuit unit 15B compares a detection current of the current detection unit 35 and a reference current and controls the pulse width modulation (PWM) duty according to a compared result thereof, and the charging circuit unit 15B performs constant current control so as to decrease or increase the PMW duty when the detection current of the current detection unit 35 is larger or smaller than the reference current. The switching element 32 may be driven or configured by similar self-elements such as a field effect transistor (FET), a TR, and a photo coupler. The charging circuit unit 15B may be configured so that the charging is performed by a constant-voltage or constant-current control method.

The temperature sensor 37 sets a reference charging current in order to prevent the battery (cell) 16A from being charged to an overcurrent, or detects an internal temperature increase due to the LED module 13 to set a full-charging voltage of the battery (cell) 16A and switch a high-speed charging to a slow-speed charging upon reaching a predetermined temperature. The temperature sensor 37 may be used by a thermistor in which a resistance value is increased according to an increase of the temperature, a bimetal, and a temperature switch.

FIGS. 7 and 8 are a detailed configuration block diagram of a power failure detection determining unit and a detecting method of a detection unit in an exemplary embodiment of a power failure detecting system of an LED light according to the present invention.

Referring to FIG. 7, the power failure detection and determination unit 14 is configured by a detection unit 50, an amplifying unit 51, an live-wire detection unit 52, and a switching unit 53 so that non-contact type voltage detection may be performed in the electric wire 54 of the LED light receiving the external power.

In the exemplary embodiment of the power failure detecting system of the LED light, in FIG. 8, as another form in the detection unit 50,

The detection unit 50 is configured in a coli form in which a cable conductor core wire is surrounded and may be manufactured to operate by induced electromotive force due to the current flowing in the conductor core wire. In addition, a configuration of 4-1 illustrated in FIG. 8 exemplifies that the detection unit 50 is formed in a spiral shape, a ring shape, or a “C” shape to determine whether the current flows in the conductor core wire in the electric wire 54, and 50a of FIG. 8 exemplifies that the detection unit 50 is divided into two groups of a current rectifying diode and a decompression resistor and a capacitor and a decompression resistor to be described below.

Further, the current rectifying means and the decompression resistor 41 operated by a direct current are connected to each other to supply the signal of the amplifying unit 51 and determine whether the induced current flows or not.

4-2 illustrated in FIG. 8 is an example in which in a closed circuit formed by a power failure detection and determination circuit, the current rectifying diode 40 and the decompression resistor 41 are additionally interposed to apply an optimal driving voltage to the power failure detection and determination circuit, and in the closed circuit of the detection unit 50a, the current rectifying diode 40 and the decompression resistor 41 are additionally interposed to apply an optimal driving voltage to the power failure detection and determination circuit. Here, the current rectifying diode is connected to the current rectifying means corresponding to a single diode or a bridge diode to rectify AC electromotive force induced or input in the power failure detection and determination unit 14 to a direct current.

4-3 illustrated in FIG. 8 is an example in which a capacitor 42 for voltage drop and the decompression resistor 41 are additionally interposed to apply the optimal driving voltage to the power failure detection and determination circuit.

In the closed circuit formed by the power failure detection and determination circuit, the decompression resistor 41 for voltage drop is additionally interposed to apply the optimal driving voltage to the power failure detection and determination circuit.

Here, in the DC, the capacitor is an insulator, but in the AC, the capacitor may be a kind of resistor according to a frequency. However, unlike a general resistor, since the capacitor is not an effective resistor, the capacitor may be used instead of the resistor on the purpose of reducing the high voltage without the loss, and may verify an operation as a voltage divided state of a pure resistor when viewing the circuit by calculating the capacitor 42 with an AC resistor of 60 Hz.

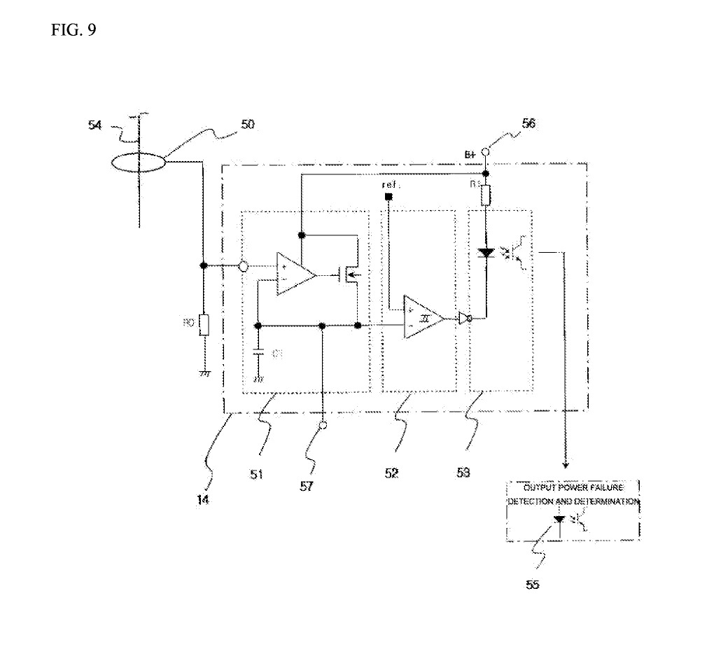

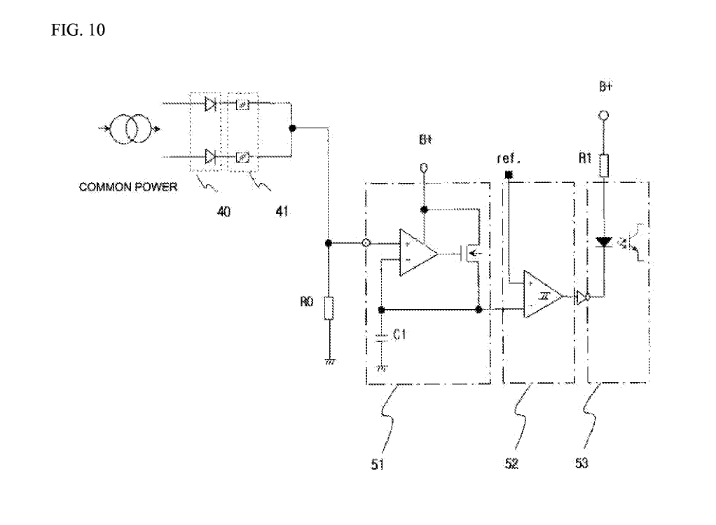

FIGS. 9 and 10 are circuit diagrams illustrating an example of a power failure detection discriminating output and a circuit of the detection unit of the power failure detecting system of an LED light according to the present invention.

Referring to FIGS. 9 and 10, the circuit diagram is illustrated by substituting the above components with the amplification unit 51, the live wire sensing unit 52, and the switching unit 53, operating power input terminals of reference numerals 56 and 57 in to which power of the sensing unit 50 and power of the converter or the capacitor are input, and the amplification unit 51 in which an OP amplifier that performs an amplification operation is electrically connected with the sensing unit 50 so as to determine whether the electrical wire 54 is a live wire may constitute a circuit that when a predetermined potential is sensed on or input into the electrical wire 54, maintains the potential to be amplified or a predetermined potential level to be detected, the switching unit 53 finally converts, when a live wire sensing unit 52 senses the input predetermined potential level and outputs a signal in response to a predetermined signal input into the live wire sensing unit 52, a signal input into the amplification unit 51 as an input signal to be output to an output portion of the amplification unit 51 into an electrical output signal is constituted by the power failure sensing determination unit 14, and as a result, the electric wire 54 that receives an external power input of the LED light supplies a live wire recognition signal to determine whether a power fail occurs, and FIG. 10 is a circuit diagram constituted by the OP amplifier and the comparator by substituting a TR or other similar elements, as an operation of the comparator, the comparator compares voltage acquired from the signal of the amplification unit 51 with predetermined reference voltage (ref.) to output an output signal as High or Low when the corresponding voltage is lower than the ref. and will be capable of changing an output signal by using a separate inverter circuit, and an LED that reacts to the live wire sensing unit 52 constituted by the OP amplifier or the comparator presented in FIGS. 9 and 10 may show a power failure sensing determination output by using a similar electrical switching structure such as, for example, the control switching element (a relay, a photocoupler, or an FET) 55 that operates in response to the switching unit 53.

In addition, if the current does not flow in the conductor, since ionization is not generated and thus the undercurrent is not generated, the current does not flow and the output is not generated in the detection units 50 and 50a, and as a result, in the LED light device described above which is the output device, the power failure state is determined, and the state in which the voltage is not applied to the electric wire 54 is detected. The amplification degree is properly reduced according to a voltage of the conductor, a refinement state of the insulating material, and a separation distance if necessary, and further, as the amplitude of the input current (undercurrent) input to the detection unit 50 is changed according to the separation distance from the detection unit, the power failure may be easily determined in proportion to the changed amplitude as the output value of the power failure determination.

The present invention having the above configurations provides a charging device and a power failure detecting system of the LED light or a power failure detection and determination device of the LED light that may check a current conduction state of the electric wire in the LED light and may not require installation of a ground wire and a configuration of a complex circuit.

### INDUSTRIAL APPLICABILITY

The exemplary embodiments of the present invention are described by using the examples used in the LED light, but may be applied to other devices such as equipment requiring emergency measures against the power interruption in homes or factories in addition to the LED light and various problems which occur when the secondary battery is used in industrial or home portable electronic apparatuses can be overcome and the emergency lighting device can be easily used in actual emergency, and rapid charging is enabled within a short time to ensure people's views in emergency to be variously applied manufactured as a technology of a charging apparatus of the LED light, and as a result, it should be appreciated that this also included in the appended claims.

1. A charging system of an LED light, comprising: a converter configured to transform common power input from the outside from DC power to AC power or from the DC power to the DC power; a power failure detection and determination unit configured to determine the power failure by detecting whether an electric wire receiving external power is a live wire; a charging unit selectively configured by a charging transformation unit transforming the input power of the converter to a predetermined value, and a charging circuit unit receiving the power supplied from the charging transformation unit to generate a signal controlling a charging current of a battery or an auxiliary power input terminal receiving external auxiliary power; a power storage unit configured by a battery electrically connected to the charging unit to charge the common power and a low voltage control unit configured to interrupt an electric output when the voltage of the battery is less than a predetermined value; an output transformation unit configured to transform the output power of the power storage unit to a predetermined value; a switching unit configured to determine and output the power input to the converter and the power storage unit by receiving the signal of the power failure detection and determination unit during the power failure in which the external power is not input and a selective control unit configured to receive an event signal according to an external sensor detection input; a constant current control unit configured to transform the output power of the selective control unit to a constant current; and an LED module installed with one or a plurality of LEDs electrically connected with the constant current control unit.

2. The charging system of the LED light of claim 1, wherein the charging transformation unit is configured to a transformation unit which decompresses or steps-up the voltage of the power input from the converter, and the output transformation unit is configured to decompresses or steps-up and outputs the power of the power storage unit.

3. The charging system of the LED light of claim 1, wherein the charging unit to which the power is input to the input terminals of the converter power and the auxiliary power received from the outside includes a PWM generator controlling a duty of pulse width modulation (PWM), a switching element performing switch-driving according to the duty control of the charging unit, and a sensor detecting a temperature and a current of the power charging unit and controlling the duty of the PWM, and controls the PWM of the charging power of the battery by receiving a full-charging voltage of the battery to interrupt and control the supply of the charging power.

4. The charging system of the LED light of claim 1, wherein the power storage unit is provided as one or more of a nickel-hydride battery, a lithium polymer battery, a lithium-iron phosphate battery, a hybrid capacitor and an electric double-layer capacitor, and a hybrid battery.

5. The charging system of the LED light of claim 1, wherein the selective control unit is configured to transfer an event signal to an alarm signal to generate an alarm sound or an alarm voice or drive self-circuits for lighting an alarm lamp, and additionally, in any one of the charging unit 15, the charging circuit unit 15B, or the power storage unit 16, a full-charging indicator, a low voltage indicator, or a charging amount displaying indicator is configured.

6. The charging system of the LED light of claim 1, wherein the selective control unit is configured by selecting one or more of a vibration sensor, a flame sensor, a PIR sensor, an illumination sensor, a radio receiver as an event signal input to the selective control unit, and determines lighting or not of the LED module by the PIR sensor or the illumination sensor, the earthquake by the vibration, the fire by the flame detection, and the disaster information and the power failure signal by the radio receiver individually allocated to the LED light to perform lighting on or off of the LED module.

7. The charging system of the LED light of claim 6, wherein the radio receiver, in which a unique number (or ID) is allocated for each radio receiver individually allocated to the LED light is configured to selectively control the lighting on or off of the LED module.

8. The charging system of the LED light of claim 1, wherein the power failure detection and determination unit is configured to be driven by the converter power or the power of the power storage unit, and the converter further includes an EMI filter and a fuse for interrupting electronic waves in the external power input terminal.

9. The charging system of the LED light of claim 1, wherein the selective control unit is a means for receiving a user's lighting on/off operation command, and the selective control unit includes one or more of a mechanical key button, a touch sensor, and a remote receiving unit, and the like.

10. The charging system of the LED light of claim 1, wherein the charging unit includes a switch means S1 which is turned on to be divided in parallel between cells configured with a plurality of batteries in series when the power supply of the charging unit is determined to be evenly charged, and a control means controlling to be electrically connected between the plurality of cells in series while a switch means S2 configured to be electrically connected between the cells in series when the switch means S1 is turned on is turned off, and a signal according to a full-charging of each cell or the S1 during discharging is turned off, and the S2 is turned off.

11. The charging system of the LED light of claim 10, wherein the charging unit is configured by selecting any one of the switch means S1 which is turned on to be divided in parallel between the plurality of cells configured in series to be evenly charged and a switch means S2 configured to be electrically connected between the plurality of cells in series.

12. A power failure detecting device of an LED light, comprising: a detection unit coupled with a part in a power failure detection and determination unit of the LED light so as to determine a power failure by detecting whether an electric wire receiving external power is a live wire or not, by surrounding an outside of the electric wire receiving the external power input; an amplifying unit configured to detect a signal induced by forming the detection unit in a ring shape or C shape along the outside of the electric wire and amplify and output a predetermined potential input signal input to the detection unit; a live-wire detection unit configured to detect a signal of the amplifying unit to output the signal according to the determination whether the predetermined potential is input; and a switching unit configured to determine and output the input signal of the live-wire detection unit, wherein when it is determined as a power failure in which the external power supply is not input to the electric wire, a power failure detection and determination output according to a switching element for controlling in which an output signal of the switching unit is output to an optimal driving voltage is included.

13. The power failure detecting device of the LED light of claim 12, wherein the power failure detection and determination unit performs voltage detection by detecting an undercurrent flowing in the electric wire receiving the external power input and amplifying the input signal according to the detection of the undercurrent flow.

14. A power failure detection and determination device of an LED light, comprising: a decompression means connected to an electric wire supplying external DC power or AC power; and a power failure detection and determination unit connected to the decompression means, wherein the power failure detection and determination unit determines that the electric wire is in a live-wire state when the current flow is detected in the power failure detection and determination unit.

15. A charging system for an LED light including the power failure detection and determination device of claim 14.

16. The power failure detection and determination device of the LED light of claim 14, wherein the power failure detection and determination unit further includes an amplifying unit amplifying an input signal decompressed according to the current flow detection.

17. The power failure detection and determination device of the LED light of claim 14, wherein the power failure detection and determination unit further includes a switching unit outputting the live-wire state of the electric wire as an electric signal value.

18. The power failure detection and determination device of the LED light of claim 14, wherein the decompression means is configured by a decompression resistor, a capacitor for voltage drop, or a combination of a current rectifying diode and the decompression resistor, and further includes a combination of the capacitor for voltage drop and the decompression resistor.
